(19) United States
(12) Patent Application Publication
(10) Pub. No.: US 2022/0363395 A1
(43) Pub. Date: Nov. 17, 2022

(54) Airline Seat Child Canopy

(71) Applicant: Catherine Linda Katz, Ann Arbor, MI (US)

(72) Inventor: Catherine Linda Katz, Ann Arbor, MI (US)

(21) Appl. No.: 17/317,064

(22) Filed: May 11, 2021

(51) Int. Cl. B64D 11/06

(52) U.S. Cl. CPC B64D 11/0612; B64D 11/0606

(57) ABSTRACT

A system and method for providing a child canopy for an economy and premium economy airline seat is disclosed. The apparatus is comprised of a light weight, flexible, canopy with mesh windows that is detachably-affixed to existing seats. A lower portion of said canopy is attached to a seat back tray table and an upper portion is connected to a seat back or a seat back head rest. An object of the invention is to provide privacy and limit distraction to a child passenger at rest in an economy airline seat.

### FIELD OF THE INVENTION

The present invention generally relates to seating. More specifically it relates to an economy and premium economy airline seating accessory that enhances child comfort and privacy.

### BACKGROUND

The first reusable tents can be traced back to the early Iron Age. Tents are mentioned in the Bible and were made from animal hide or leather, using wooden supports, ropes and wooden stakes support—this basic design and construction method did not significantly change for 40 or 50 thousand years. The tents used by the Roman Army were also normally made of leather, and enough is known about the designs that some good examples of this type of tent have been built in modern times. A wide variety of tent styles and sizes were used by the Roman Army. During the 1800s and up through the mid-1900s armies relied on portable canvas tents with wooden poles to house troops in the field. In more recent times, manufacturers like the Eureka and North Face began to producing recreational tents made of light weight, moisture-resistant fabrics such as Goretx™ that helped grow the camping and outdoor industry at the start of the 20th Century. Today's tents can often be setup extremely quickly and are made from lightweight material such as rip-stop nylon, are easy to carry and are very resistant to the elements. Tents have now become part of modern seating. Korean Patent No. KR20010070907A and United States Patent No. US20060220424A1 teach of portable chairs that provides a roof and side panels for shade and comfort. U.S. Pat. No. 6,296,002B1 disclosed a metal-framed, portable chair with a tent canopy. United States Patent No. US20030010371A1 teaches of a miniature tent and chair that can be used at outdoor stadiums to protect from rain. United States Patents No. US20030111102A1, US20140007912A1 and U.S. Pat. No. 6,109,281A disclosed a small canopy tent to provide shade while in the sun. None of the aforementioned patents found were designed to be installed on existing airline seats. What is needed is a small, personalized tent canopy that can be used in airliner seats for children to provide enhanced privacy.

### SUMMARY OF THE INVENTION

The device herein disclosed and described provides a solution to the shortcomings in the prior art through the disclosure of a system and method to enhance child privacy while seated in economy and premium economy airline seating. The apparatus spans the space between a seat tray table and the seatback. An object of the tent canopy is to provide seclusion and minimize distractions so a child can rest during prolonged air travel.

Another object is to allow children to see out of the child canopy and also allow parents nearby to check in on them. The child canopy includes a roof and side windows with translucent mesh material.

Another object is to provide access to the child canopy from different sides. The system includes side panels that can be rolled up and secured by means of a small strap on either side.

Another object is to provide a means to dismantle the apparatus during an inflight emergency. Small buckles are provided on each strap that quickly disengage the canopy. During an emergency, the parent or child quickly unbuckles the strap which allows the space to become available.

Another object is to allow the apparatus to be easily transported. The apparatus is made of a thin, light weight fabric that allows it to be rolled up and transported in a bag or back pack.

It is briefly noted that upon a reading this disclosure, those skilled in the art will recognize various means for carrying out these intended features of the invention. As such it is to be understood that other methods, applications and systems adapted to the task may be configured to carry out these features and are therefore considered to be within the scope and intent of the present invention, and are anticipated. With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention. As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of indicates that the listed elements are required or mandatory, and that no other elements may be present.

By “consisting essentially of is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements. The objects features, and advantages of the present invention, as well as the advantages thereof over existing prior art, which will become apparent from the description to follow, are accomplished by the improvements described in this specification and hereinafter described in the following detailed description which fully discloses the invention, but should not be considered as placing limitations thereon.

### BRIEF DESCRIPTION OF THE FIGURES

The accompanying drawings, which are incorporated herein and form a part of the specification, illustrate some, but not the only or exclusive, examples of embodiments and/or features.

FIG. 1 shows a perspective view an over-the-seatback child canopy embodiment.

FIG. 2 shows a perspective view a head rest child canopy embodiment.

FIG. 3 shows a perspective view of the child canopy with the sides rolled up.

FIG. 4 shows a perspective sectional view a head rest child canopy embodiment.

FIG. 5 shows a bottom view a head rest child canopy embodiment.

FIG. 6 shows a perspective sectional view a head rest child canopy embodiment.

FIG. 7 shows a perspective view an over-the-seatback child canopy embodiment.

FIG. 8 shows a perspective view an over-the-seatback child canopy embodiment.

FIG. 9 shows a perspective view an over-the-seatback child canopy embodiment.

FIG. 10 shows a perspective sectional view a head rest child canopy embodiment.

FIG. 11 shows a representative view of the method of the child canopy.

Other aspects of the present invention shall be more readily understood when considered in conjunction with the accompanying drawings, and the following detailed description, neither of which should be considered limiting.

### DETAILED DESCRIPTION OF FIGURES

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation. Conventional components of the invention are elements that are well-known in the prior art and will not be discussed in detail for this disclosure.

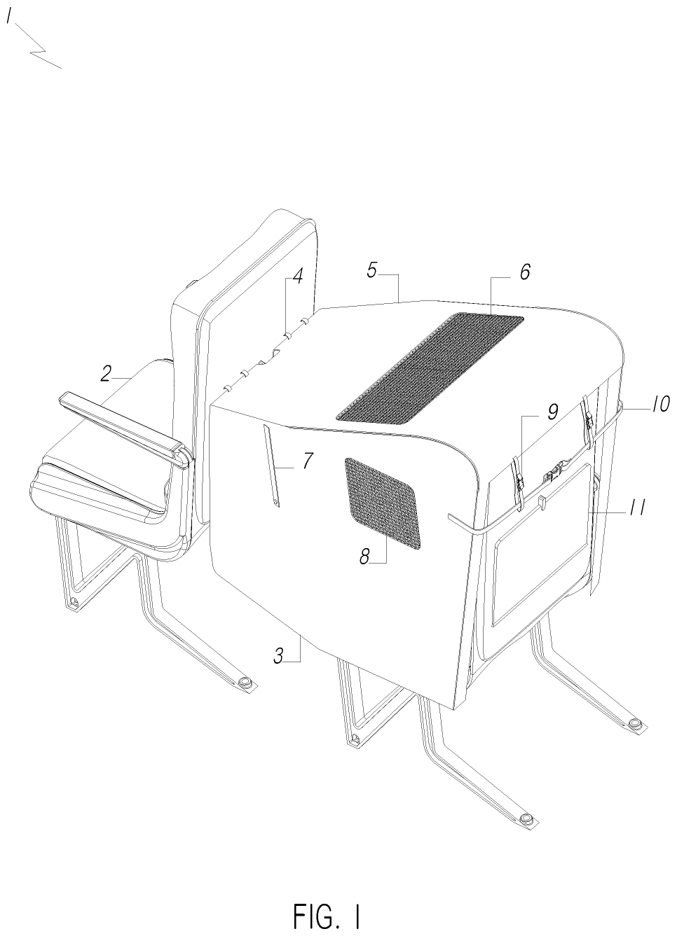

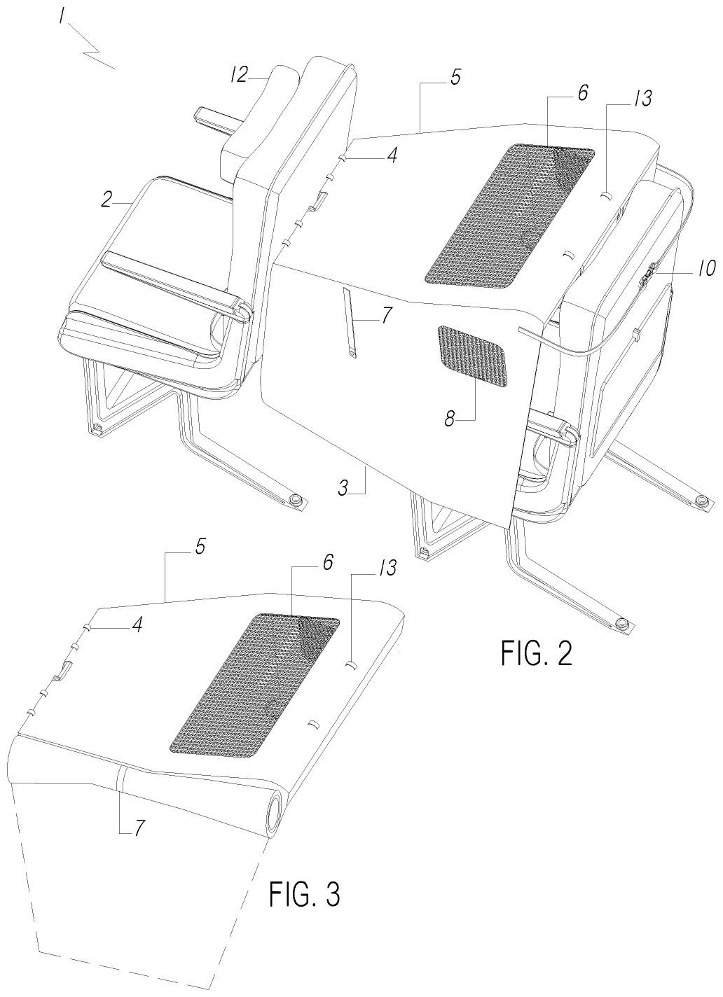

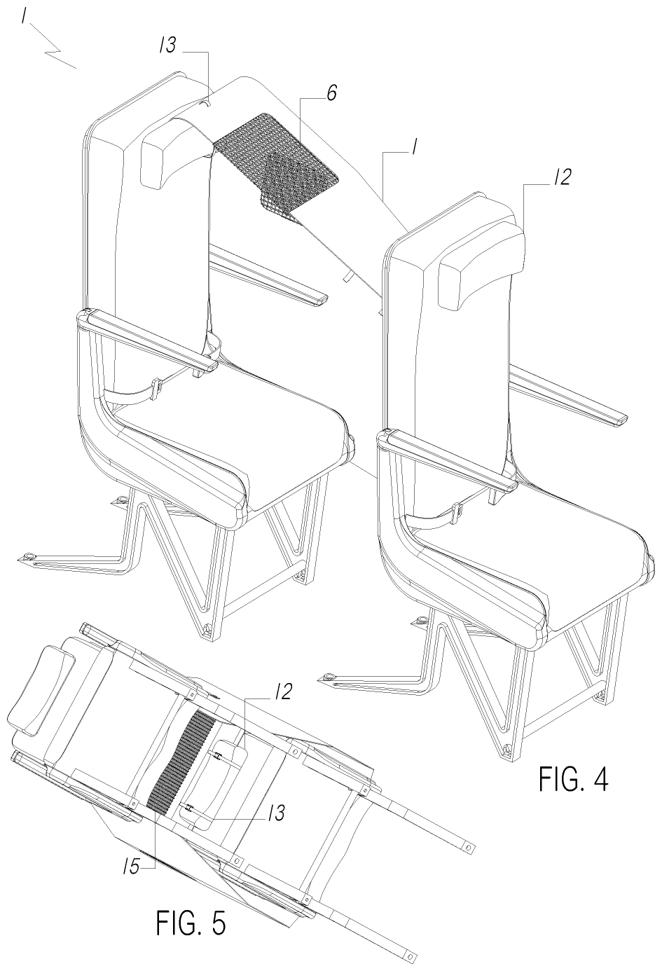

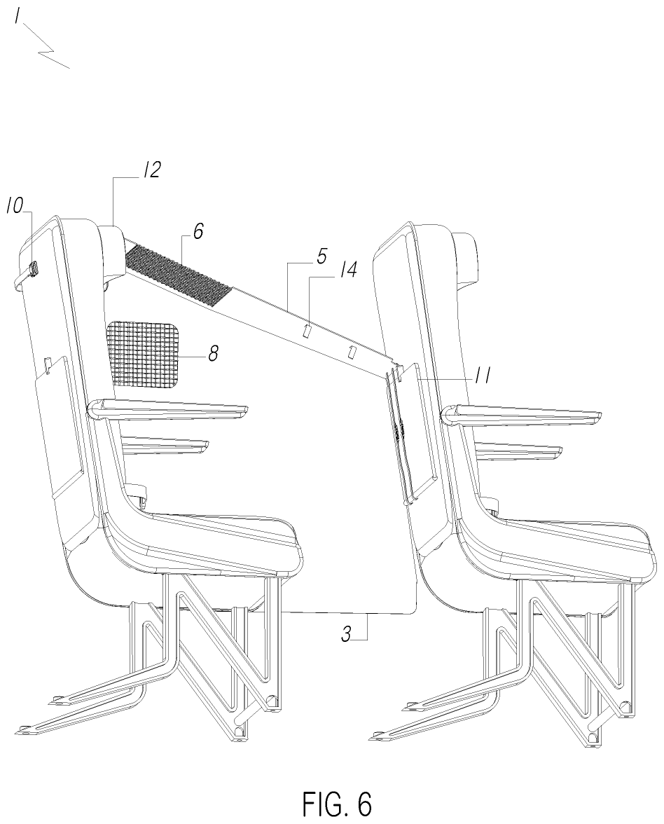

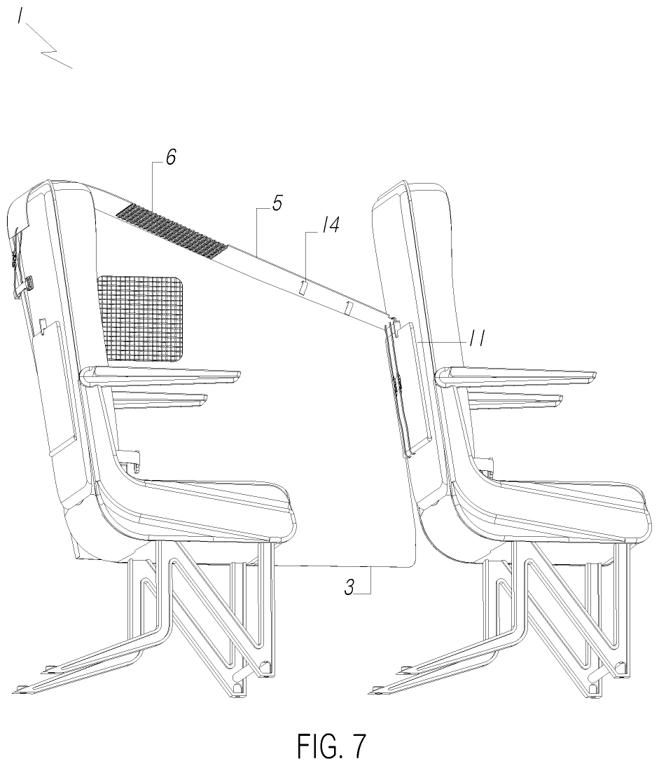

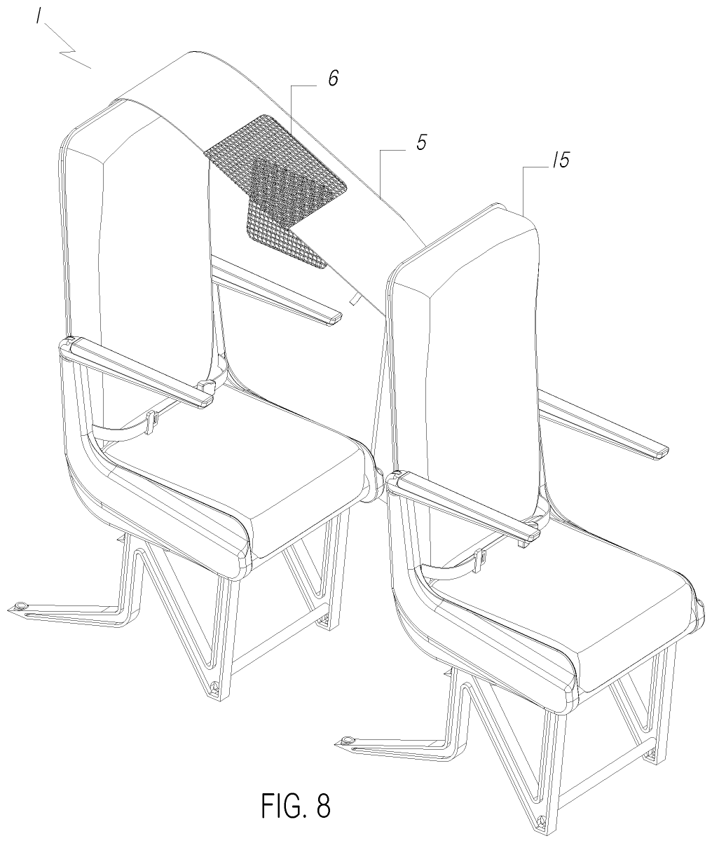

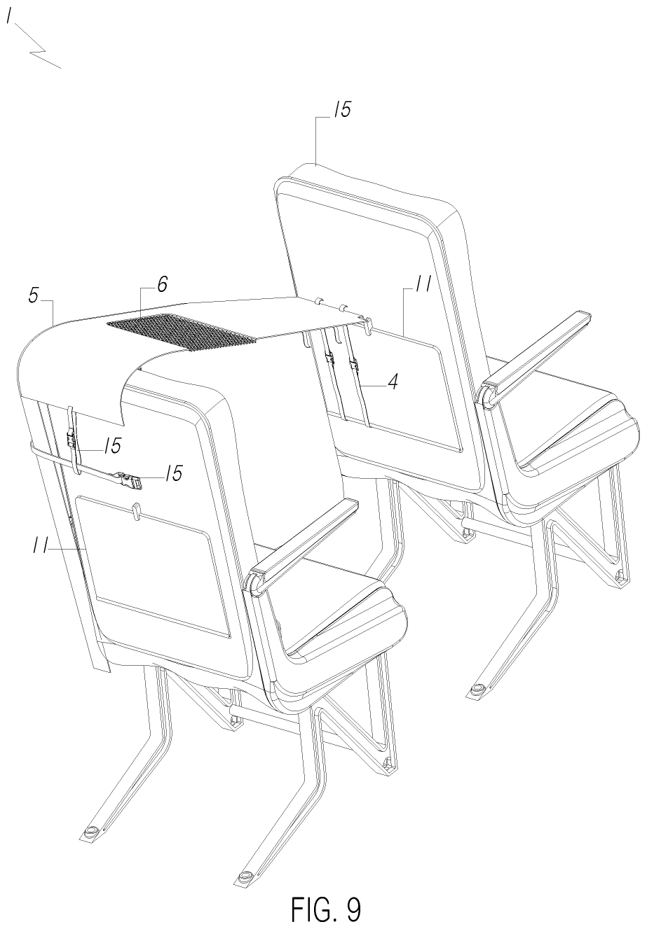

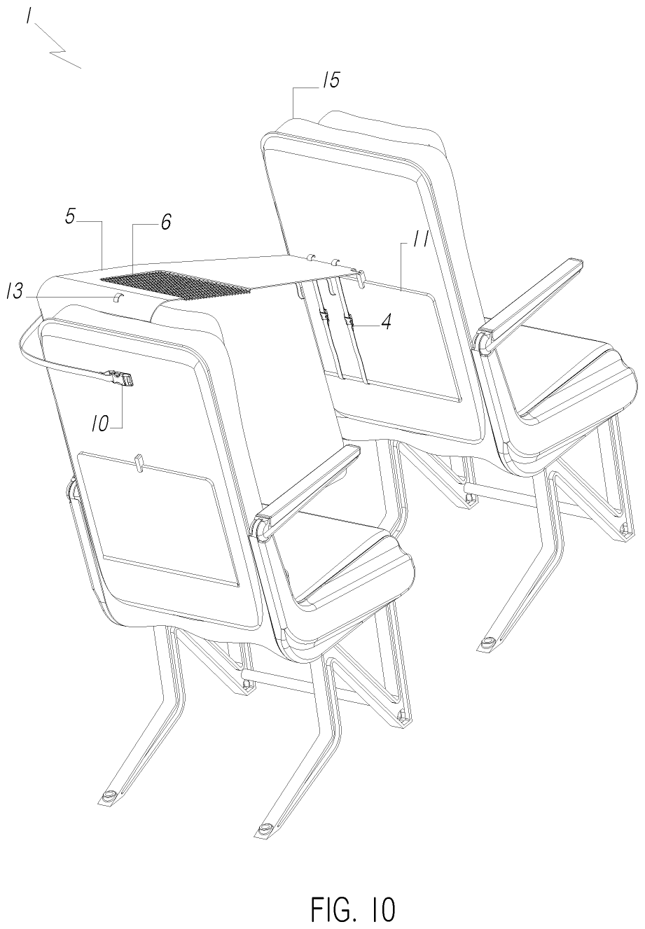

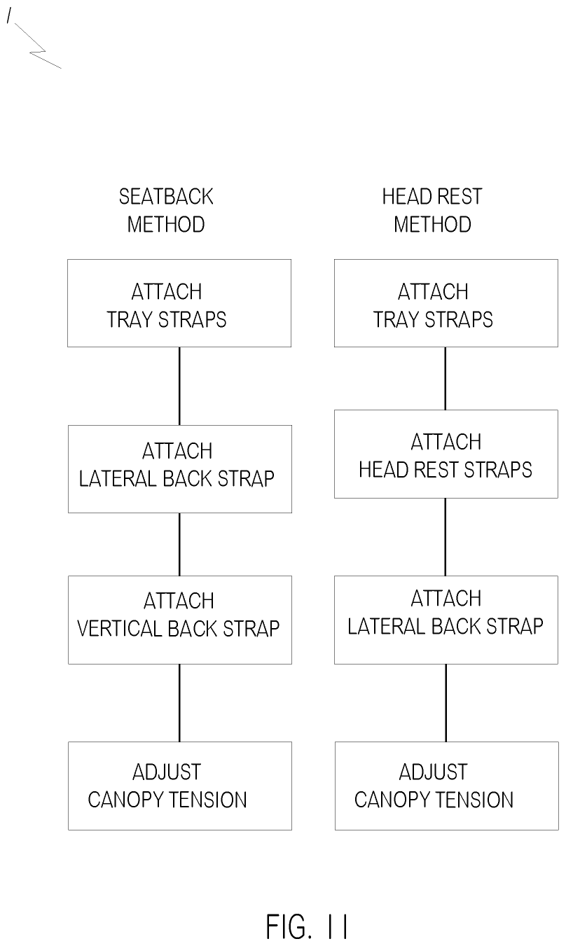

FIGS. 1-10 show various perspective views of seatback and head rest embodiments of the airline economy seat child canopy apparatus 1. The canopy 5 being comprised of a light-weight, sheet material, such as but not limited to: nylon; polypropylene; cotton; polyester and the like and having a shape that when installed onto a conventional, economy airline seat 2 becomes cube-shaped. The figures show the canopy 5 having a roof portion with a roof window 6 disposed proximally and being made of a translucent material including but not limited to: mesh fabric, plastic screen and a clear plastic etc. and sidewalls 3 that can be rolled up and secured by means of side straps 7 secured to side walls 3. Said sidewalls 3 also having screens 8 disposed proximally and being made of a translucent material including but not limited to: mesh fabric, plastic screen and a clear plastic etc. The side straps 7 having anchor fasteners that include but are not limited to: snaps, buttons, buckles and the like. One end of the canopy 5 having a multitude of adjustable tray table straps 4 that are detachably-affixed to conventional, airline seat tray tables 11. The aforementioned adjustable tray table straps 4 being made of an elastomer fabric and having attachment features that include but are not limited to: buckles, snaps, hook and loop fabric etc. Another end of canopy 5 also being detachably-affixed to a conventional, airline seatback by means of straps. In the headrest embodiment, at least two adjustable head rest straps 13 connect the canopy 5 to seat head rest 12 (as shown in FIG. 5) and another adjustable lateral back strap 10 provides additional support by being affixed around the seatback. Said adjustable head rest straps 13 adjustable lateral back strap 10 are also made of an elastomer fabric and having attachment features that include but are not limited to: buckles, snaps, hook and loop fabric etc. In the seatback embodiment, one end of canopy 5 having a multitude of adjustable tray table straps 4 detachably-affixed to airline seat tray tables 11 and another end connected to the seatback by means of at least two, vertical adjustable back straps 9. In this embodiment, adjustable lateral back strap 10 is looped through said vertical adjustable back straps 9. Finally, child canopy 5 having at least one, toy loop 14 that allow toys to be hung there from.

FIG. 11 showing the methods of the seatback and the headrest embodiments of the airline economy seat child canopy apparatus 1. Using the seatback embodiment, the user first attaches adjustable tray table straps to a seat tray table by looping adjustable tray table straps around a seat tray table and securing the attachment features. Secondly, the user attaches the adjustable lateral back strap by looping it around the seatback and securing the attachment feature. Thirdly, they attach vertical adjustable back strap to a seatback by looping it around the adjustable lateral back strap and securing the attachment feature. Fourthly, the user adjusts the tension of the canopy across the tray table and seatback by adjusting all strap attachment features. Using the headrest embodiment, the user first attaches adjustable tray table straps to a seat tray table by looping adjustable tray table straps around a seat tray table and securing the attachment features. Secondly, the user attaches the adjustable head rest straps to the seat headrest by looping them around said head rest. Thirdly the user attaches the adjustable lateral back strap by looping it around the seatback and securing the attachment feature. Fourthly, the user adjusts the tension of the canopy across the tray table and seatback by adjusting all strap attachment features.

It is additionally noted and anticipated that although the device is shown in its most simple form, various components and aspects of the device may be differently shaped or slightly modified when forming the invention herein. As such those skilled in the art will appreciate the descriptions and depictions set forth in this disclosure or merely meant to portray examples of preferred modes within the overall scope and intent of the invention, and are not to be considered limiting in any manner. While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the scope of the invention.

What is claimed is:

1. A child canopy for economy and premium economy airline seats comprised of the following parts:
a) a canopy;
b) side windows;
c) a roof window;
d) adjustable tray table straps;
e) vertical adjustable back straps;
f) adjustable lateral back strap;
g) adjustable head rest straps; and
h) side straps.

2. The child canopy for economy airline seats of claim 1, wherein the canopy having side walls.

3. The child canopy for economy airline seats of claim 1, wherein the side windows and roof window being made of a translucent material.

4. The child canopy for economy airline seats of claim 1, wherein the adjustable tray table straps, the vertical adjustable back straps, the adjustable lateral back strap, the adjustable head rest straps, and the side straps being made of an elastomer fabric.

5. The child canopy for economy airline seats of claim 1, wherein the adjustable tray table straps, the vertical adjustable back straps, the adjustable lateral back strap, the adjustable head rest straps, and the side straps and having attachment features.

6. The child canopy for economy airline seats of claim 1, wherein the side straps are secured to side walls.

7. The child canopy for economy airline seats of claim 1, wherein the side straps having anchor fasteners. and are secured to side walls.

8. A method for enhancing children's privacy in economy and premium economy airline seats comprising the following steps:
a) attaching adjustable tray table straps to a seat tray table;
b) attaching adjustable head rest straps to a seat head rest;
c) attaching vertical adjustable back strap to a seatback;
d) attaching adjustable lateral back strap to a seatback; and
e) adjusting tension of the canopy.

9. The method for enhancing children's privacy in economy airline seats of claim 8, wherein the attaching adjustable tray table straps to a seat tray table includes the step of looping adjustable tray table straps around a seat tray table and securing the attachment feature.

10. The method for enhancing children's privacy in economy airline seats of claim 8, wherein the attaching adjustable head rest straps to a seat head rest includes the step of looping adjustable head straps around a seat head rest and securing the attachment feature.

11. The method for enhancing children's privacy in economy airline seats of claim 8, wherein the attaching adjustable back strap to a seatback includes the step of looping the vertical adjustable back strap around the adjustable lateral back strap and securing the attachment feature.

12. The method for enhancing children's privacy in economy airline seats of claim 8, wherein the attaching adjustable lateral back strap to a seatback includes the step of looping adjustable back strap around a seatback and securing the attachment feature.

13. The method for enhancing children's privacy in economy airline seats of claim 8, wherein the adjusting tension of the canopy includes the step of adjusting the tightness of the attachment features.
